(19) United States
(12) Patent Application Publication
(10) Pub. No.: US 2024/0357052 A1
(43) Pub. Date: Oct. 24, 2024

(54) STORING VIDEO IN MEMORY

(71) Applicant: Micron Technology, Inc., Boise, ID (US)

(72) Inventor: Alyssa Scarbrough, Boise, ID (US)

(21) Appl. No.: 18/640,795

(22) Filed: Apr. 19, 2024

Related U.S. Application Data
(60) Provisional application No. 63/461,385, filed on Apr. 24, 2023.

(51) Int. Cl. H04N 5/91; H04N 5/77; H04N 5/775

(52) U.S. Cl. CPC H04N 5/91; H04N 5/77; H04N 5/775

(57) ABSTRACT

The present disclosure includes apparatuses, methods, and systems for storing video in memory. In an example, an apparatus can include a memory, a camera, and a processor coupled to the memory and the camera, wherein the processor is configured to record video via the camera, store a first portion of the video for a first particular time period in the memory, and store a second portion of the video for a second particular time period responsive to a trigger.

### PRIORITY INFORMATION

This application claims the benefits of U.S. Provisional Application No. 63/461,385, filed on Apr. 24, 2023, the contents of which are incorporated herein by reference.

### TECHNICAL FIELD

The present disclosure relates generally to apparatuses, methods, and systems for storing video in memory.

### BACKGROUND

A computing device can be a smartphone, a wearable device, a tablet, a laptop, a desktop computer, or a smart assistant device, for example. The computing device can receive and/or transmit data and can include or be coupled to one or more memory devices.

Memory devices are typically provided as internal, semiconductor, integrated circuits in computers or other electronic systems. There are many different types of memory including volatile and non-volatile memory. Volatile memory can require power to maintain its data (e.g., host data, error data, etc.) and includes random access memory (RAM), dynamic random-access memory (DRAM), static random-access memory (SRAM), synchronous dynamic random-access memory (SDRAM), and thyristor random access memory (TRAM), among others. Non-volatile memory can provide persistent data by retaining stored data when not powered and can include NAND flash memory, NOR flash memory, and resistance variable memory such as phase change random access memory (PCRAM), resistive random-access memory (RRAM), and magnetoresistive random access memory (MRAM), such as spin torque transfer random access memory (STT RAM), among others.

### BRIEF DESCRIPTION OF THE DRAWINGS

FIG. 1A illustrates an example of a computing device for storing video in memory in accordance with some embodiments of the present disclosure.

FIG. 1B illustrates an example of a computing device for storing video in memory in accordance with some embodiments of the present disclosure.

FIG. 2 illustrates a diagram of a video over time in accordance with some embodiments of the present disclosure.

FIG. 3 illustrates an example of a system for storing video in accordance with some embodiments of the present disclosure.

FIG. 4 is a flow diagram corresponding to a method for storing video in memory in accordance with some embodiments of the present disclosure.

### DETAILED DESCRIPTION

The present disclosure includes apparatuses, methods, and systems for storing video in memory. In an example, an apparatus can include a memory, a camera, and a processor coupled to the memory and the camera, wherein the processor is configured to record video via the camera, store a first portion of the video for a first particular time period in the memory, and store a second portion of the video for a second particular time period responsive to a trigger.

Often important events are not captured on video even when cameras are present because the camera is not recording. Most cameras require a record button to be pressed to start recording. In some instances, an event can be over before a user is able to press record.

Aspects of the present disclosure address the above and other deficiencies by always collecting footage. For example, a camera can always be recording, and the video can be stored until some or all of the video is determined to be important and saved or unimportant and deleted. Accordingly, important events can be captured and stored.

An artificial intelligence (AI) model can be trained to determine which portions of a video to delete and which portions of a video to store. For example, the AI model can learn to identify triggers that signify events that should be saved and store portions of the video based on those triggers. These triggers can include a user's language, vocal pitches, word choices, body language, facial expressions, and/or gestures.

As used herein, “a”, “an”, or “a number of” can refer to one or more of something, and “a plurality of” can refer to two or more such things. For example, a number of characteristics can refer to one or more characteristics, and a plurality of characteristics can refer to two or more characteristics. Additionally, designators such as “N”, as used herein, particularly with respect to reference numerals in the drawings, indicates that a number of the particular feature so designated can be included with a number of embodiments of the present disclosure.

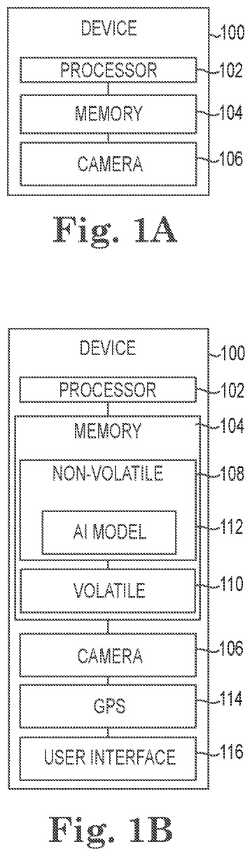

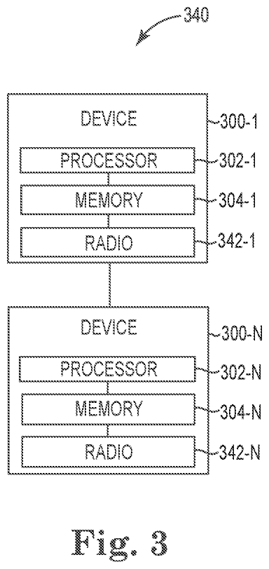

The figures herein follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 302 in FIG. 3.

FIG. 1A illustrates an example computing device 100 for storing video in memory 104 in accordance with some embodiments of the present disclosure. The computing device 100 can be, but is not limited to, a wearable device, a laptop, a tablet, and/or a mobile device. For example, the computing device 100 can be augmented reality (AR) glasses.

The computing device 100 can include a processor 102, memory 104, and a camera 106. The camera 106 can be a photo camera, a video camera, and/or an image sensor that can take photos and/or videos. The memory 104 can be any type of storage medium that can be accessed by the processing resource 102 to perform various examples of the present disclosure. For example, the memory 104 can be a non-transitory computer readable medium having computer readable instructions (e.g., computer program instructions) stored thereon that are executable by the processing resource 102 to record video via the camera 106, store a first portion of the video for a first particular time period in the memory 104, and store a second portion of the video for a second particular time period responsive to a trigger. The trigger can be a verbal or physical command from a user. The second particular time period can be longer than the first particular time period.

FIG. 1B illustrates an example of a computing device 100 for storing video in memory 104 in accordance with some embodiments of the present disclosure. Along with memory 104, the computing device 100 can include a processor 102, a camera 106, a global positioning system (GPS) 114, and a user interface 116.

As illustrated in FIG. 1B, the memory 104 can include volatile memory 110 and/or non-volatile memory 108, for instance, DRAM, NAND, and/or 3D Cross-point. The non-volatile memory 108 can store an AI model 112.

The computing device 100 can comprise hardware, firmware, and/or software configured to train the AI model 112. In a number of embodiments, the AI model 112 can be trained remotely in a cloud using sample data and transmitted to the computing device 100 and/or trained on the computing device 100.

The AI model 112 can be trained using user feedback and/or user settings. For example, a training video can be displayed on user interface 116. The user interface 116 can provide a selection to store or delete the training video to a user. The AI model 112 can train itself by identifying characteristics of the training video and pairing the characteristics with the user's selection. Accordingly, the AI model 112 can store or delete a video with similar characteristics as the training video responsive to the user's selection. Characteristics can include triggers, events, people, animals, objects, and/or locations, for example.

The user interface 116 can be generated by computing device 100. The user interface 116 can be a graphical user interface (GUI) that can provide and/or receive information to and/or from the user of the computing device 100. In some examples, the user interface 116 can be shown on a display of the computing device 100.

As used herein, the AI model 112 can include a plurality of weights, biases, and/or activation functions among other variables that can be used to execute the AI model 112. The processor 102 can include components configured to enable the computing device 100 to perform AI operations.

Video recorded by the camera 106 can be inputted into the AI model 112. In a number of embodiments, the video can be stored in the volatile memory 110 prior to inputting the video into the AI model 112.

A portion of the video can be deleted and/or a different portion of the video can be stored in the non-volatile memory 108 in response to an output of the AI model 112. In a number of embodiments, the different portion of the video can include an event. The different portion of the video can be stored in the non-volatile memory 108 and/or transmitted to an external device to prevent the different portion of the video from being erased when the computing device 100 is turned off or broken. The external device can be a cloud device or another computing device, for example.

The computing device 100 can further include GPS 114 to determine a location of the computing device 100. The GPS 114 can determine and/or store the location of the computing device 100 in response to a trigger and/or in response to the computing device 100 determining an event has occurred.

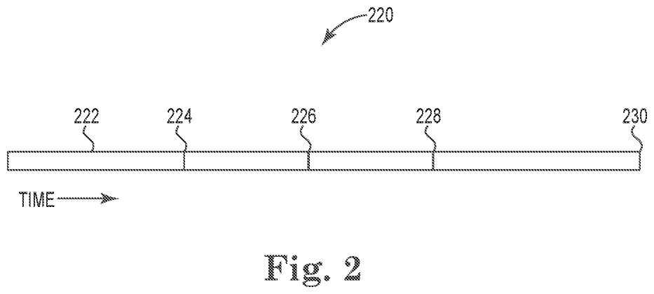

FIG. 2 illustrates a diagram of a video 220 over time in accordance with some embodiments of the present disclosure. The video 220 can be recorded using a camera (e.g., camera 106 in FIGS. 1A-1B) of a computing device (e.g., computing device 100 in FIGS. 1A-1B). The camera can begin recording the video 220 when the camera and/or computing device are turned on. In a number of embodiments, the computing device, for example a wearable, can begin recording when a user puts the wearable on. The wearable discussed herein can be AR glasses, however, any wearable or computing device can be used to record the video 220.

The AR glasses can begin recording the video 220 in response to the AR glasses being turned on, detecting movement, and/or detecting a user wearing the AR glasses, for example. The AR glasses can be turned on via a touch or voice command. Movement of the AR glasses can be detected via a gyroscope, GPS, camera, and/or an accelerometer. The AR glasses can detect a user wearing the AR glasses via a camera and/or thermal sensors.

The video 220 can be recording in the background at 222. For example, the camera can be recording the video 220 of the user running alone on a trail with no one around.

At 224, a trigger can occur. The trigger can be a person, an animal, an object, and/or a user's reaction including a user's biometric data, language, vocal pitch, vocal volume, word choice, body language, facial expression, and/or gesture. For example, a person can appear on the trail ahead of the user on the video 220 at 224. A timestamp at 224 can be stored in response to the person appearing or the reaction of the user to the person appearing. In some examples, the user being startled and making an unusually quick movement may be the trigger that causes the computing device to store a timestamp at 224.

An event can occur at 226. The event can be a portion of the video 220 the user would like saved. For example, the user can be attacked and/or robbed at 226 by the person. In a number of embodiments, another timestamp at 226 can be stored in response to a person, an animal, an object, and/or a user's reaction. For example, the timestamp at 226 can be stored in response to the user saying “help” or “stop”.

In some instances, the user may be able to provide a command to the computing device to record the event at 228. For example, the user can activate the camera to ensure the camera is recording the attack and/or robbery at 228 by providing a vocal command to record. In a number of embodiments, the user can provide a touch command on the AR glasses to record.

The camera and/or computing device can stop recording at 230. For example, the event can end, the user can stop the recording, and/or the camera and/or computing device can be destroyed and/or turned off at 230. To prevent the camera from prematurely stopping the recording prior to the end of the event, the camera may only stop recording in response to a command from the user. For example, the computing device may only follow commands to stop recording issued by the voice or touch of the user to prevent an attacker and/or robber from stopping the recording.

To preserve the event and/or trigger, portions of the video 220 identified by the timestamps at 224, 226, and 228, can be stored in non-volatile memory and/or streamed to and/or stored on cloud devices and/or other computing devices. This enables the event and/or trigger to be saved in case the AR glasses are turned off, damaged, or destroyed. For example, if the attacker and/or robber breaks the AR glasses to stop the recording, the video 220 may be able to be extracted from the non-volatile memory if still intact or from the cloud and/or other computing devices.

As illustrated in FIG. 2, the command from the user to record at 228 may come during or after the event at 226. Accordingly, recording the video 220 before receiving a command can capture an event and/or a portion of an event that may not have been captured.

In a number of embodiments, the computing device can store portions of the video 220 that fall within a range of the command to record at 228. For example, the computing device can store a particular time period of video 220 proceeding and a particular time period of video 220 following the command to record at 228. The portion of video 220 proceeding and following the command to record at 228 can be stored in non-volatile memory and/or streamed to and/or stored on cloud devices and/or other computing devices to keep the portion of video 220.

In some examples, other portions of the video 220 can be deleted. For example, the entire video 220 can be stored for a time period. If portions or the entire video 220 are determined to lack a trigger, an event, and/or a command, the portions or the entire video 220 can be deleted after the time period has passed. The entire video 220 can be stored temporarily on volatile memory until the portions or the entire video 220 are deleted or transferred to non-volatile memory and/or memory external to the computing device. Portions or the entire video 220 can be deleted to free up space in memory.

FIG. 3 illustrates a schematic diagram of a system 340 for storing video (e.g., video 220 in FIG. 2) in accordance with some embodiments of the present disclosure. The system 340 can include one or more computing device 300-1, . . . , 300-N, which can correspond to computing device 100 in FIGS. 1A-1B. The one or more computing devices 300-1, . . . , 300-N, collectively referred to as computing devices 300, can be cloud devices, wearable devices, mobile devices, tablets, laptops, desktop computers, personal assistants, or any combination thereof. Computing device 300-1 can include a memory 304-1 and processor 302-1 and computing device 300-N can include a memory 304-N and processor 302-N, which can correspond to memory 104 and/or processor 102 in FIGS. 1A-1B.

Radio 342-1 and radio 342-N can be included in computing device 300-1 and computing device 300-N, respectively. Radio 342-1 and radio 342-N can be collectively referred to as radios 342. Each of the computing devices 300 can receive and/or transmit requests, commands, and/or data via each of the radios 342.

The radios 342 can communicate via a network relationship through which the computing devices 300 communicate with one another. Examples of such a network relationship can include Bluetooth, AirDrop, a peer-to-peer Wi-Fi network, a cellular network, a distributed computing environment (e.g., a cloud computing environment), a wide area network (WAN) such as the Internet, a local area network (LAN), a personal area network (PAN), a campus area network (CAN), or metropolitan area network (MAN), among other types of network relationships. In a number of embodiments, the computing devices 300 can receive and/or transmit requests, commands, and/or data using Bluetooth when the computing devices 300 have poor or no internet connection.

In a number of embodiments, radio 342-1 of computing device 300-1 can transmit video to radio 342-N of computing device 300-N. Computing device 300-1 can transmit the video to computing device 300-N in response to identifying an event and/or a trigger, for example. Transmitting the video can preserve the event, trigger, and/or video in case computing device 300-1 and/or its memory 304-1 is destroyed. Computing device 300-N can store the video in memory 304-N in response to receiving the video.

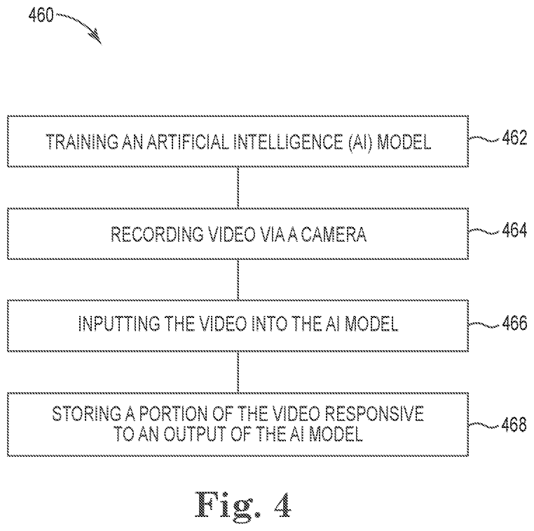

FIG. 4 is a flow diagram corresponding to a method 460 for storing video in memory in accordance with some embodiments of the present disclosure. The method 460 may be performed, in some examples, using a computing device such as those described with respect to FIG. 3.

At 462, the method 460 can include training an AI model (e.g., AI model 112 in FIG. 1B). The AI model can be trained remotely in a cloud or other computing device using sample data and transmitted to the computing device. In a number of embodiments, the computing device can include hardware, firmware, and/or software to train the AI model on the computing device. The AI model can be trained using user feedback and/or user settings.

For example, the method 460 can further include displaying a different video on a user interface (e.g., user interface 116 in FIG. 1B) of the computing device. A selection to store or delete the different video can be provided to a user in response to displaying the different video on the user interface.

The AI model can identify characteristics of the different video and pair the characteristics with the selection to train itself. Accordingly, the AI model can output the command the user selected when a video with the same or similar characteristics (e.g., having a threshold number of characteristics in common) to the different video is inputted into the AI model. For example, if the AI model identified laughter in the different video and the user selected to store the different video, the AI model can store any video in which it identifies laughter.

In a number of embodiments, the computing device can provide an additional selection to allow the user to choose what type of memory or where to store the different video. For example, the user could select to store the different video on volatile memory (e.g., volatile memory 110 in FIG. 1B), non-volatile memory (e.g., non-volatile memory 108 in FIG. 1B), or on an external computing device.

Accordingly, the AI model can select the type or location of the memory when a video with the same or similar characteristics to the different video is inputted into the AI model. For example, if the AI model identified a confrontation in the different video and the user selected to store the different video on memory of an external computing device, the AI model can transmit any video in which it identifies a confrontation to the memory of the external computing device.

The method 460 can include recording video via a camera (e.g., camera 106 in FIGS. 1A-1B) at 464. The camera can begin recording the video when the camera and/or computing device are turned on. In a number of embodiments, the computing device, for example a wearable, can begin recording when a user puts the wearable on or receives a touch or voice command. Once the camera and/or computing device is on, a video can be recording in the background. The video can be stored in volatile memory until the video is inputted into the AI model.

At 446, the method 460 can include inputting the video into the AI model. A processor (e.g., processor 302 in FIG. 3) of the computing device can include components configured to enable the computing device to perform AI operations. The AI model can identify triggers, events, and/or commands and determine the video and/or portions of the video can be deleted, stored, and/or transmitted.

In a number of embodiments, the AI model can further transmit data to emergency services or an emergency contact. For example, the AI model can transmit a GPS location determined by a GPS (e.g., GPS 114 in FIG. 1) of the computing device, the video, and/or portions of the video to emergency services or an emergency contact.

The method 460 can include storing a portion of the video responsive to an output of the AI model at 468. In a number of embodiments, other portions of the video can be deleted. For example, the entire video can be stored for a time period. If portions of the video are determined to lack a trigger, an event, and/or a command, those portions can be deleted after the time period has passed. The entire video can be stored temporarily on volatile memory until the portions or the entire video are deleted or transferred to non-volatile memory and/or memory external to the computing device.

The time period can be a pre-set time on the computing device. The time period can be set and/or changed by the user. In some examples, the computing device can prompt the user to select the time period. The time period may be adjusted by the computing device based on the availability of memory. For example, the time period may decrease responsive to the available memory decreasing or the time period may increase responsive to the available memory increasing. In a number of embodiments, the time period may be increased by the computing device responsive to the entire video and/or portions of the video including a threshold number of triggers, events, and/or commands.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one.

Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus comprising:
a memory;
a camera; and
a processor coupled to the memory and the camera, wherein the processor is configured to:
record video via the camera;
store a first portion of the video for a first particular time period in the memory; and
store a second portion of the video for a second particular time period responsive to a trigger.

2. The apparatus of claim 1, wherein the apparatus is a wearable device.

3. The apparatus of claim 2, wherein the wearable device is augmented reality (AR) glasses.

4. The apparatus of claim 1, wherein the trigger is a verbal or physical command from a user of the apparatus.

5. The apparatus of claim 1, wherein the second particular time period is longer than the first particular time period.

6. The apparatus of claim 1, further comprising a global position system (GPS) configured to determine a location of the apparatus.

7. The apparatus of claim 6, wherein the memory is configured to store the location of the apparatus responsive to the trigger.

8. An apparatus comprising:
a camera;
a memory configured to store an artificial intelligence (AI) model; and
a processor coupled to the memory and the camera, wherein the processor is configured to:
record video via the camera;
store the video in the memory;
input the video into the AI Model; and
delete a portion of the video responsive to an output of the AI model.

9. The apparatus of claim 8, wherein the memory further comprises volatile memory.

10. The apparatus of claim 9, wherein the processor is configured to store the video in the volatile memory.

11. The apparatus of claim 8, wherein the processor is configured to store a different portion of the video responsive to the output of the AI model.

12. The apparatus of claim 11, wherein the memory further comprises non-volatile memory, and wherein the processor is configured to store the different portion of the video in the non-volatile memory.

13. The apparatus of claim 8, wherein the processor is configured to transmit a different portion of the video responsive to the output of the AI model.

14. The apparatus of claim 13, wherein the processor is configured to transmit the different portion of the video to an external device.

15. The apparatus of claim 14, wherein the external device is a cloud device or computing device.

16. A method comprising:
training an artificial intelligence (AI) model;
recording video via a camera;
inputting the video into the AI model; and
storing a portion of the video responsive to an output of the AI model.

17. The method of claim 16, further comprising displaying a different video on a user interface.

18. The method of claim 17, further comprising providing a selection to store or delete the different video to a user responsive to displaying the different video on the user interface.

19. The method of claim 18, further comprising identifying characteristics of the different video.

20. The method of claim 19, further comprising training the AI model using the selection and the characteristics of the different video.
